(19) United States
(12) Patent Application Publication
(10) Pub. No.: US 2002/0039268 A1
(43) Pub. Date: Apr. 4, 2002

(54) Arc protection relay

(76) Inventors: Lyle Stanley Bryan, Kernersville, NC (US); John Steven Cowan, Winston-Salem, NC (US)

Correspondence Address: Tyco Technology Resources, Suite 450, 4550 New Linden Hill Road, Wilmington, DE, 19808-2952, US

(21) Appl. No.: 09/966,125

(22) Filed: Sep. 28, 2001

Related U.S. Application Data
(60) Provisional application No. 60/236,758, filed on Sep. 29, 2000.

(51) Int. Cl. H02H 3/00

(52) U.S. Cl. 361/42

(57) ABSTRACT

An arc protection relay, particularly suited for use in 42 volt automotive systems applications has input terminals for connection to an external power source; output terminals for connection to an inductive load; a contact connected in series to the input terminal and the output terminal; a relay coil connected to the input terminals and operatively connected to the contact; and at least one energy absorbing device, such as a metal-oxide varistor or a transient surge suppressor, connected in parallel with the output terminals for absorbing fluctuating reverse voltage from the output terminals and optionally contains a second energy absorbing device in the form of a coil suppressor for protecting the coil from voltage surges and a magnet operatively positioned to blow an arc from the contact.

### FIELD OF THE INVENTION

A relay having built-in arc protection is provided for use in relatively high voltage applications. In particular, the arc protection relay of the present invention may be used in 42 volt automotive applications.

### BACKGROUND OF THE INVENTION

Due to the increasing electrical demands of electrical and electronic devices in automobiles, supplying a vehicle with adequate power is becoming more difficult. Entertainment and media systems, climate controls and other electronic devices raise electrical power consumption in an automobile.

As such, automotive manufacturers are moving from a 14 volt power system to a 42 volt system. This increase in power delivery has resulted in the need to modify traditional electrical systems within a vehicle. One area negatively affected by the increase in supply voltage is in electromechanical relays used throughout vehicles to perform electrical switching. These relays typically have very closely spaced movable contacts which perform the actual switching and which are susceptible to being damaged from the increased voltage in the circuit. The damage is caused by arcing, which occurs when a relay is de-energized and current attempts to jump across the open switching contacts.

Because the supply voltage is relatively high, switching contacts should be spaced very far apart (on the order of 10 mm) in order to eliminate the potential of an arc jumping across the contacts. As space is a precious commodity in an automobile, increasing the gap between switching contacts to 10 mm is not desirable or practical. As such, another means must be provided to prevent arcing across switching contacts, while still having a relatively close contact gap.

### BRIEF DESCRIPTION OF THE DRAWINGS

FIG. 1 is a graph of voltage versus current, upon which various minimum contact gaps are plotted.

FIGS. 2A and 2B illustrate a traditional relay circuit wherein the movable contacts are open and closed, respectively.

FIG. 3 is a graph showing current versus time and voltage versus time in the circuit shown in FIG. 2.

FIGS. 4A and 4B is a relay circuit as shown in FIGS. 2A and 2B wherein a magnet is introduced.

FIG. 5 is a graph showing current versus time and voltage versus time for the circuit shown in FIG. 4.

FIG. 6 is a relay circuit having an energy absorber, such as a metal oxide varistor or transient surge suppressor, placed in parallel with a relay coil and switching contacts.

FIG. 7 is a relay circuit, similar to that of FIG. 6, in which a diode is placed in parallel to the relay coil.

FIG. 8 is a graph showing current versus time and voltage versus time for the circuit shown in FIG. 6 using a metal oxide varistor as the energy absorber.

FIG. 9 is a graph showing current versus time and voltage versus time for the circuit shown in FIG. 6 using a transient surge suppressor as the energy absorber.

### DETAILED DESCRIPTION OF THE INVENTION

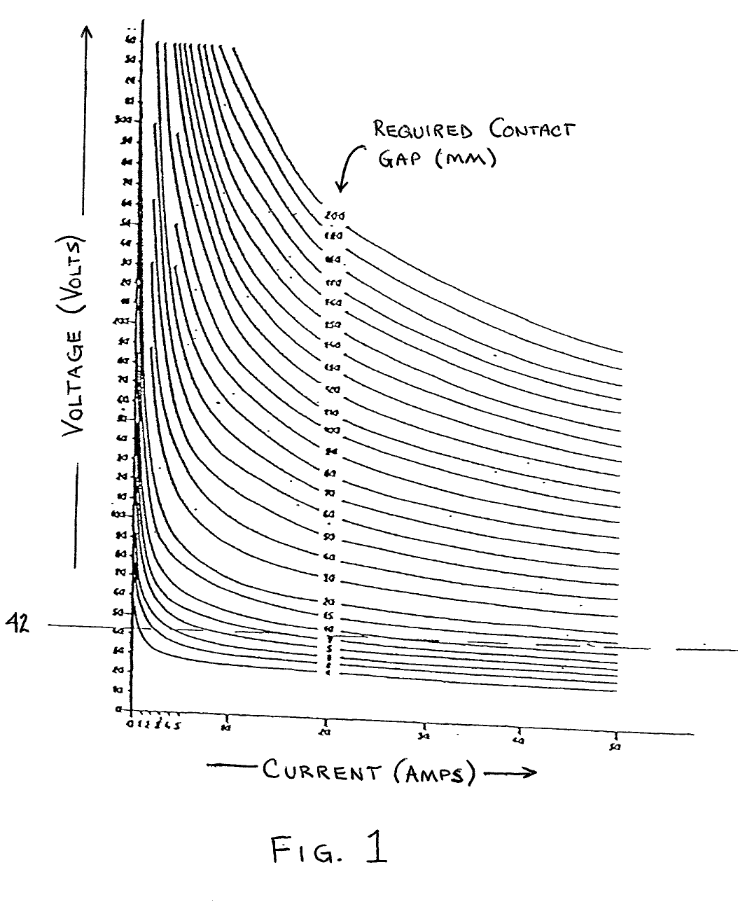

FIG. 1 is a graph showing the minimum contact gap required to avoid arcing across the contacts at 20 amps at various voltages. Values in millimeters (mm) are indicated vertically on the graph at 20 amps for each respective voltage. As can be seen, in a conventional 14 volt (V) system, arcing across the contacts is of little concern. However, at 42V (as indicated by a horizontal line), a minimum contact gap of between 9 mm and 10 mm is required to prevent arcing. Often, in practice, the contact gap is as small as 0.5 mm. Consequently, arcing will almost always occur across the contact gap in a 42V system.

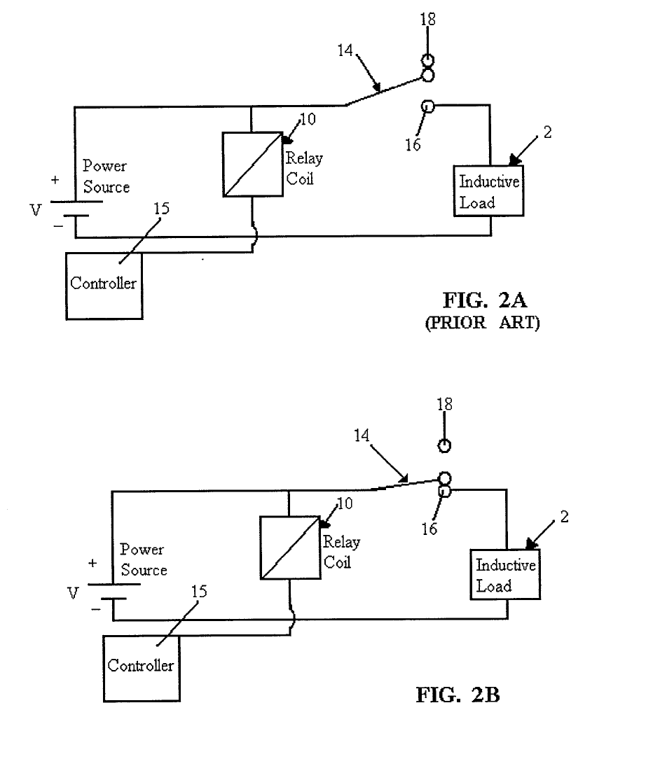

FIGS. 2A and 2B show a schematic representation of a conventional 14V system, wherein an inductive load 2 is connected across a power source V (in this case V=14 volts) and current to the load is regulated by way of relay coil 10 in which the relay coil 10 controls movable contact 14.

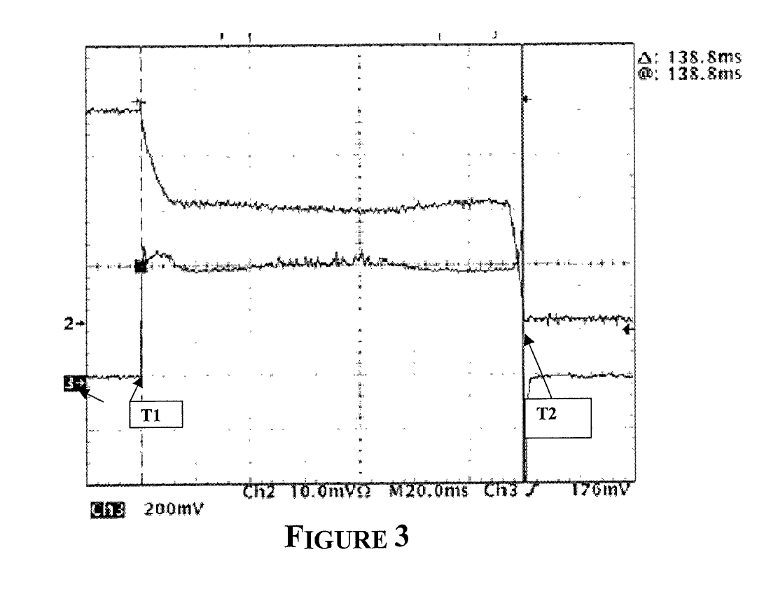

FIG. 3 shows voltage and current measurements taken across the movable contact 14 and the normally open contact 16, focusing on when relay coil 10 is de-energized and movable contact 14 opens and moves away from contact 16 to contact 18. In this example, the power source V is set at 44V. The graph also shows the behavior of the circuit shown in FIG. 2 just prior to de-energizing the coil. Time is shown in milliseconds (ms) across the horizontal axis of the graph. At time T1=20 ms, the relay coil 10 is de-energized. The lower portion of the graph shows the voltage rising from 0V to approximately 20V. Current is shown in the upper portion of the graph dropping from 20 amps to approximately 10 amps. At 20V with 10 amps of current flowing, a standing arc is burning across the contact gap. This arc can severely damage the contacts. In the instance shown in FIG. 3, the arc “burns” between T1=20 ms and T2=160 ms, or for approximately 140 ms. The longer the arc burns, the more damage is done to the contacts each time the relay coil is de-energized. Only when power is removed from the movable contact of the relay under test by a master relay (in this case at T2=158.8 ms) is the arc extinguished. At T2, after a brief transient period of reverse voltage, the voltage is 0V and the current is 0 amps.

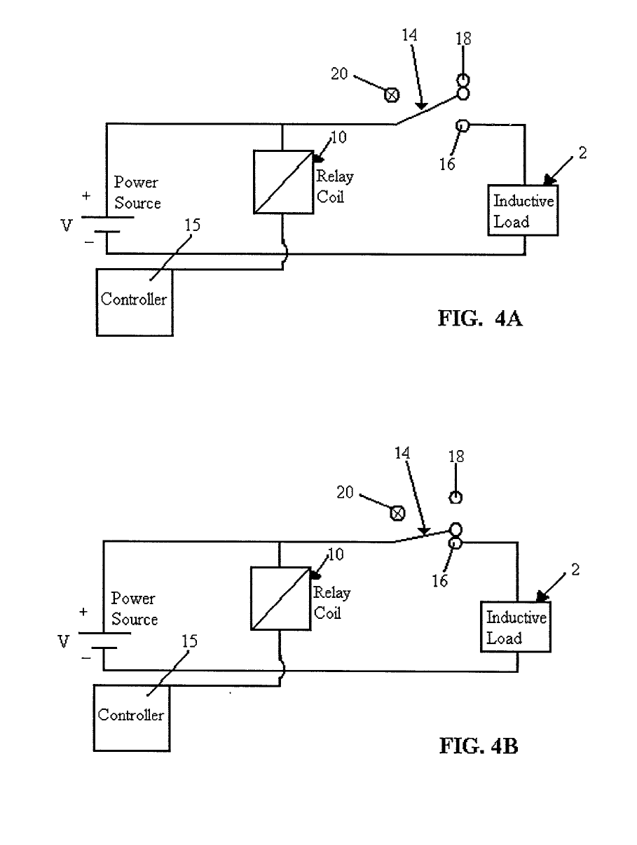

FIG. 4 shows a circuit schematic in which the circuit shown in FIG. 2 is modified to introduce a magnet 20 to minimize the burn time of the arc. Magnets have been used in arc protection to “deflect” an arc by either attracting or repelling the arc, depending upon the polarity of the magnet with respect to the induced electromagnetic field caused by the flow of current manifested in the form of an arc. In this circuit, the magnet is placed approximately 3.5 mm away from the contacts 14, 16, 18 and is used to deflect the arc away from the contacts.

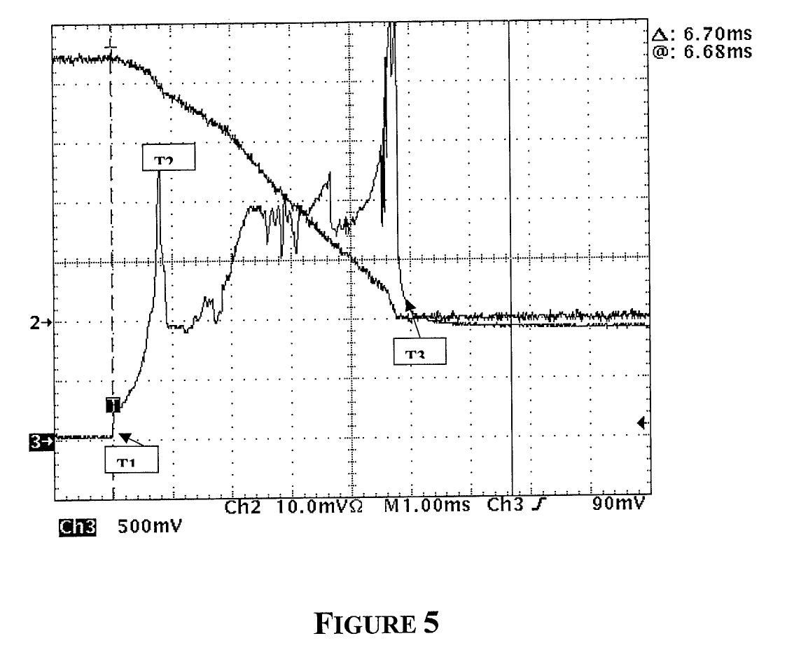

FIG. 5 is a graph, similar to that shown in FIG. 3, illustrating the behavior of the circuit of FIG. 4 when the relay coil 10 is de-energized. At T1=1 ms, the relay coil is de-energized. Voltage drops to 0V at approximately T3=5.8 ms. Accordingly, the arc is extinguished after approximately 4.8 ms.

With an arc burn time of approximately 4.8 ms, the arc is drastically reduced as compared to the circuit of FIG. 2. However, it is interesting to note the behavior of the voltage between T2 and T3 in FIG. 5. The voltage spike shown between time T2 and T3 illustrates that the arc is battling to re-establish itself. Ultimately, at T3 the voltage goes back to 0 volts and the current goes to 0 amps. However, between T2 and T3, the arc is attempting to re-ignite.

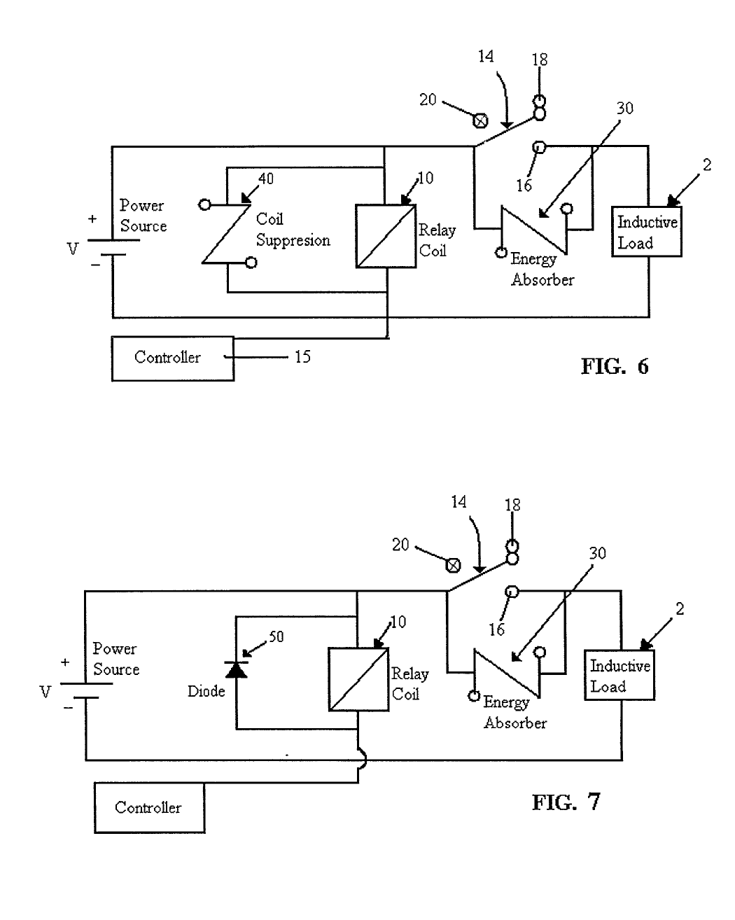

To eliminate this problem, the circuit shown in FIGS. 6 and 7 are proposed. The voltage spike occurring between T2 and T3 in FIG. 5 is the result of energy reflecting back from the inductive load, creating a fluctuating reverse voltage. This energy, unless absorbed, will seek a ground and is likely to manifest itself as an arc across the contacts. The circuit shown in FIGS. 6 and 7 thus introduces an energy absorber 30 in parallel with the switching contacts. The energy absorber 30 can be any device capable of absorbing the fluctuating reverse voltage in the circuit. Particularly preferred devices include a metal-oxide varistor (“MOV”) and a transient surge suppressor (“TSS”). A MOV is a non-linear resistor that acts as a transient, or surge, absorber and has a resistance that decreases as voltage increases. MOV's and TSS's are well known, commercially available electronic protection devices. An example is the 1.5KE Series transient suppressors available from Sussex Semiconductor, Inc. in Fort Myers, Fla.

In the circuit shown in FIGS. 6 and 7, the energy absorber 30 is connected such that current will flow through the energy absorber 30 when the relay coil is de-energized and the inductive load causes a reverse voltage to be present across the load. That is, when a reverse voltage is present across the inductive load, current is able to flow back through the energy absorber 30, thereby reducing the probability of arcing across the movable contact 14 and contact 16.

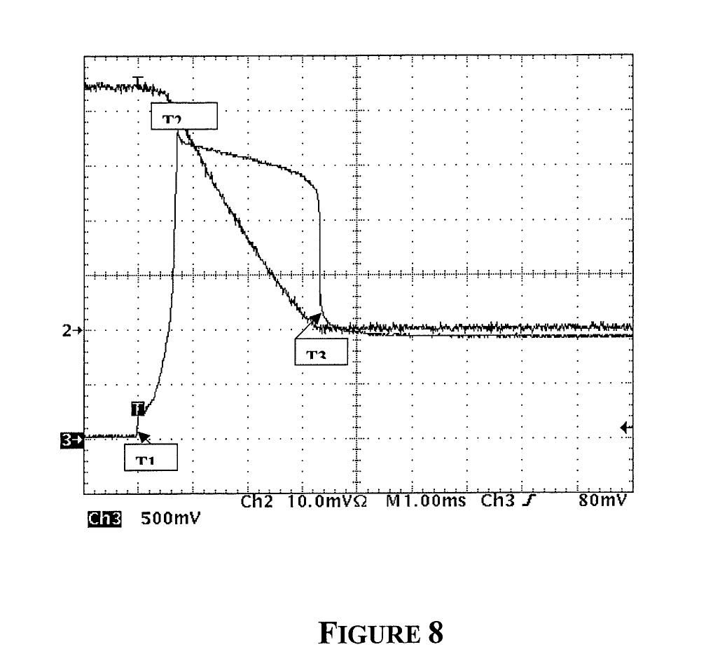

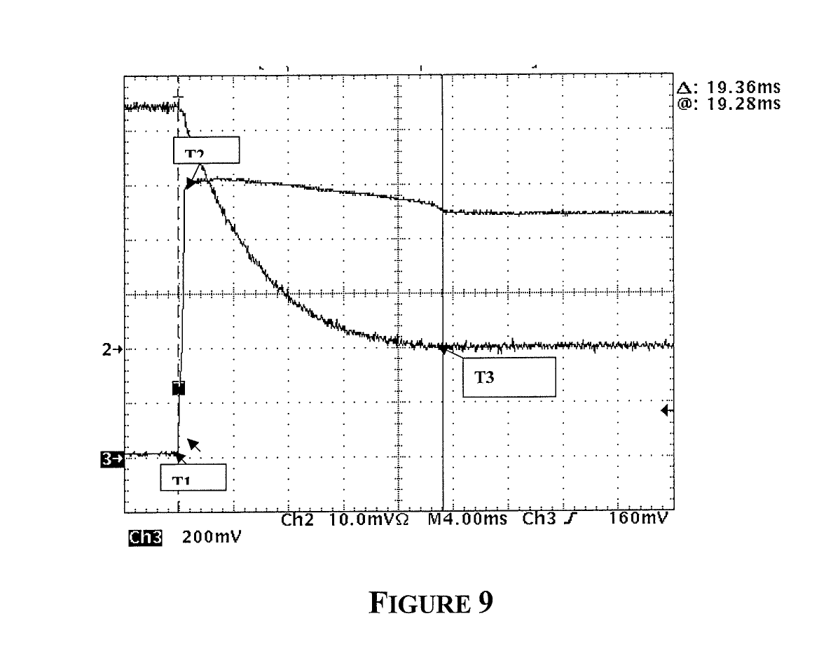

FIG. 8 shows a graph of voltage and current as a function of time for the circuit of FIG. 6. At time T1=1 ms, the relay coil 10 is de-energized. Within approximately 0.8 ms, or at time T2=2.8 ms, the arc is extinguished. At T2, current has dropped approximately 17 amps, but continues to flow through energy absorber 30 until time T3=4.3 ms. At T3, current is at 0 amps and voltage approaches the source voltage 44 volts. More importantly, between T2 and T3 there are no voltage spikes. In other words, the arc is not trying to re-ignite because the current is allowed to flow back through the energy absorber 30.

Therefore, by using the circuit shown in FIGS. 6 and 7, the arc burn time is reduced to less than a millisecond and there is no tendency for the arc to re-ignite. Thus, a circuit is provided which is capable of handling relatively high voltages while greatly increasing the life of the contacts by minimizing arc time.

The circuit shown in FIG. 6 also includes a second energy absorber in the form of coil suppression device 40 connected across the relay coil 10. When a relay is de-energized, the built-in inductance of the coil attempts to maintain the voltage across the coil. This can cause massive surges in voltage that often damage the start lead of the coil. By attaching the coil suppression device 40 across the relay coil 10, current is allowed to flow through the coil suppression device 40 upon de-energizing the relay. As such, the coil is protected from voltage surges. In an alternate embodiment shown in FIG. 7, a diode 50 is connected across the relay coil in lieu of the coil suppression device 40.

In the automotive industry, a relay, such as those shown in the various figures, is controlled by a controller 15 connected to the relay. For instance, an automobile may have automatic windows operated by a manual switch that a driver presses to open and close a window. The switch is connected to a controller that actuates the relay. The relay is then energized or de-energized, thereby affecting the inductive load (such as a motor to crank the window). This may happen several times each time the automobile is operated. These relays are populated throughout the vehicle. And, with a 42V power source, protecting the relays is essential. The foregoing invention accomplishes this effectively and at a relatively low cost.

One embodiment of the invention uses the circuit shown in FIG. 6, wherein energy absorber 30 and coil suppression device 40 are 65 Volt devices rated at 82 varistor volts±10%, with a surge current rating of 600 amps. Panasonic sells a metal-oxide varistor meeting these specifications under part number ERZ-V05D820. Additionally, a simple switching diode configured as in FIG. 7 can be used for coil suppression. The relay (including the relay coil 10 and contacts 14, 16, 18) may be rated at 6335 turns with SKO-41 AWG wire with a 775 ohm resistance±5%. A Neodinium 35SH magnet may be used for magnet 20. As already mentioned, the 1.5KE Series transient suppressors from Sussex Semiconductor, Ft. Myers, Fla. can also be used to advantage.

It should be understood to those skilled in the technology that the foregoing invention may be used in various fields other than the automotive industry. Furthermore, it should be apparent that energy absorbers and surge suppressors may be selected having varying voltage ratings depending upon the application and that other relays may be employed having ratings different than the embodiment specifically set forth above. Likewise, various magnets may be employed depending upon the requirements of the specific application.

What we claim is:

1. An arc protection relay comprising input terminals for connection to an external power source; output terminals for connection to an inductive load; a contact connected in series to the input terminal and the output terminal; a relay coil connected to the input terminals and operatively connected to the contact; and at least one energy absorbing device connected in parallel with the output terminals for absorbing fluctuating reverse voltage from the output terminals.

2. The arc protection relay of claim 1, further comprising a second energy absorbing device connected across the relay coil for protecting the relay coil from voltage surges.

3. The arc protection relay of claim 2, wherein said second energy absorbing device comprises a coil suppressor device.

4. The arc protection relay of claim 3, wherein the coil suppression device comprises a metal-oxide varistor.

5. The arc protection relay of claim 3, wherein the coil suppression device comprises a common switching diode.

6. The arc protection device of claim 4, further comprising a magnet operatively positioned to reduce burn time of an arc on the contacts.

7. The arc protection device of claim 2, further comprising a magnet operatively positioned to reduce burn time of an arc on the contacts.

8. The arc protection device of claim 1, further comprising a magnet operatively positioned to reduce burn time of an arc on the contacts.

9. The arc protection relay of claim 1, wherein said at least one energy absorbing device is selected from a metal-oxide varistor and a transient surge suppressor.

10. The arc protection device of claim 1, wherein said input terminals are connected to a 42 volt power source.
